(19) United States
(12) Patent Application Publication
(10) Pub. No.: US 2008/0307457 A1
(43) Pub. Date: Dec. 11, 2008

(54) CHANNEL SWITCHING METHOD AND METHOD AND APPARATUS FOR IMPLEMENTING THE METHOD

(75) Inventors: Do-Jun YANG, Yongin-si (KR); Mun-Jo KIM, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/924,043

(22) Filed: Oct. 25, 2007

(30) Foreign Application Priority Data
Jun. 11, 2007 (KR) 10-2007-0056861

(51) Int. Cl. G06F 3/00

(52) U.S. Cl. 725/38

(57) ABSTRACT

A channel-switching method and apparatus are provided. The channel-switching method includes switching from a first channel to a second channel, outputting a partial video corresponding to the second channel on a screen while main data of the second channel is being buffered to be output, and outputting the main data of the second channel on the screen.

### CROSS-REFERENCE TO RELATED APPLICATION

This application claims priority from Korean Patent Application No. 10-2007-0056861 filed on Jun. 11, 2007 in the Korean Intellectual Property Office, the disclosure of which is incorporated herein by reference in its entirety.

### BACKGROUND OF THE INVENTION

1. Field of the Invention

Methods and apparatuses consistent with the present invention relate to channel-switching, and more particularly, to channel-switching that can remove a blank period caused by a delay in the switching from one Internet Protocol television (IPTV) channel to another.

2. Description of the Related Art

With the rapid increase in network speed and the development of Internet Quality-of-Service (QoS) technology, an IPTV, which can provide existing digital broadcast services such as satellite, cable, and terrestrial broadcast services through the Internet, has been developed. Since the advent of the IPTV, various products and standards regarding the IPTV have been developed, and extensive research on the IPTV is being conducted.

The IPTV can provide various information services, moving video content and broadcast programs to TV sets using a high-speed Internet network. In this regard, the IPTV is deemed a key example of the digital convergence between the Internet and TV services. The IPTV is distinguished from an Internet TV in that the IPTV uses a television set and a remote control instead of a computer monitor and a mouse.

The IPTV provides TV services using the Internet protocol, and involves transmission of data to a network through a broadband connection. The IPTV additionally provides Video-on-Demand (VOD) services and Internet services such as web access and Voice-over-Internet Protocol (VoIP) services.

In order to use an IPTV service, a TV set and a set-top box are simply connected to the Internet. That is, a set-top box or an IPTV modem is connected to a TV set, and the TV set is turned on. Therefore, even users who are not familiar with computers can easily perform an Internet search, view various content such as movies through the Internet, and use various additional services such as home shopping, home banking, online games, and Moving Picture Experts Group-I Audio Layer 3 (MP3) services.

The IPTV is no different from cable broadcasting or satellite broadcasting in that a same kind of broadcast content such as video content is provided. Since the IPTV is bidirectional, services such as interactive services or personalized services can be provided. For example, the IPTV can provide an interactive program guide which can help a user to conduct a content search using the title of the content or the name of an actor/actress. Also, the IPTV can provide a combination of three different services such as video, audio, and Internet services via a single line connection. That is, the IPTV can service TV, telephone, and Internet services using single line connection.

In the case of a related art digital broadcast service, the same content is transmitted to every subscriber. Thus, a cable or satellite broadcast service provider can only transmit content allowed within the limitation of a connection a subscriber has in home, and the subscriber can choose from a limited amount of content. In contrast, the IPTV provides a subscriber with content selected by the subscriber. Thus, IPTV is relatively free from the problem of a bandwidth shortage, and can allow a subscriber to choose content without being affected by bandwidth limitation.

However, the IPTV may have the following problems when switching channels. In order to receive a broadcast program from a channel to which a user wishes to switch, a predetermined multicast address must be accessed through a network using an IPTV terminal. However, during the attempt to access the predetermined multicast address, a network delay may occur. In addition, in order to display video data corresponding to the desired channel on a TV screen, a certain amount of data needs to be buffered. A delay caused by the buffering may produce a blank period during which no image is visible to the user.

Therefore, it is desirable to remove the blank period caused by the delay when switching channel in an IPTV, and thus to optimize IPTV channel switching.

### SUMMARY OF THE INVENTION

The present invention provides an optimization of IPTV channel switching by providing data corresponding to a desired Internet Protocol Television (IPTV) channel to which a user wishes to switch, during a blank period caused by a delay when switching to the desired IPTV channel.

However, aspects of the present invention are not restricted to exemplary embodiments set forth herein. The aspects of the present invention will become apparent to one of ordinary skill in the art to which the present invention pertains by referencing the detailed description of the exemplary embodiments of the present invention given below.

According to an aspect of the present invention, there is provided a broadcast-transmission apparatus including a frame-extraction module which periodically extracts partial videos from video data respectively corresponding to each of a number of channels currently being serviced; a zapping-channel-generation module which generates a zapping channel by multiplexing the partial videos; and a zapping-channel transmission module which transmits the multiplexed partial videos of the zapping channel.

According to another aspect of the present invention, there is provided a method of providing data of a zapping channel, the method including periodically extracting partial videos from video data respectively corresponding to each of a number of channels currently being serviced; generating a zapping channel by multiplexing the partial videos; and transmitting the multiplexed partial videos the zapping channel.

According to another aspect of the present invention, there is provided a broadcast-reception apparatus including a zapping-channel-reception module which receives data included in a zapping channel that is obtained by multiplexing a number of partial videos of video data corresponding to a number of channels currently being serviced; a zapping-channel-demultiplexing module which obtains a number of partial videos respectively corresponding to the channels by demultiplexing the data included in the zapping channel; and a zapping-channel output module which outputs a partial video obtained by the zapping-channel-demultiplexing module on a screen upon switching channels.

According to another aspect of the present invention, there is provided a method of outputting data of a zapping channel, the method including receiving data included a zapping channel which is obtained by multiplexing a number of partial videos of video data corresponding to a number of channels currently being serviced; obtaining a number of partial videos respectively corresponding to the channels by demultiplexing the data included the zapping channel; and outputting an obtained partial video on a screen upon switching channels.

According to another aspect of the present invention, there is provided a channel-switching method including switching from a first channel to a second channel; outputting a number of partial videos corresponding to the second channel on a screen; and outputting main data of the second channel on the screen.

### BRIEF DESCRIPTION OF THE DRAWINGS

The above and other aspects of the present invention will become apparent by describing in detail exemplary embodiments thereof with reference to the attached drawings, in which:

FIG. 1 is a schematic diagram of a broadcasting system according to an exemplary embodiment of the present invention;

FIG. 2 is a block diagram of a broadcast-transmission apparatus according to an exemplary embodiment of the present invention;

FIG. 3 illustrates the generation of a zapping channel by the broadcast-transmission apparatus illustrated in FIG. 2, according to an exemplary embodiment of the present invention;

FIG. 4 is a flowchart illustrating a method of providing a zapping channel according to an exemplary embodiment of the present invention;

FIG. 5 is a block diagram of a broadcast-reception apparatus according to an exemplary embodiment of the present invention;

FIG. 6 is a flowchart illustrating a method of outputting a zapping channel according to an exemplary embodiment of the present invention; and

FIG. 7 is a flowchart illustrating a channel-switching method according to an exemplary embodiment of the present invention.

### DETAILED DESCRIPTION OF EXEMPLARY EMBODIMENTS

The present invention will now be described more fully with reference to the accompanying drawings, in which exemplary embodiments of the invention are shown. The invention may, however, be embodied in many different forms and should not be construed as being limited to the exemplary embodiments set forth herein; rather, these exemplary embodiments are provided so that this disclosure will be thorough and complete, and will fully convey the concept of the invention to those skilled in the art. Like reference numerals in the drawings denote like elements, and thus their description has been omitted.

The present invention is described hereinafter with reference to flowchart illustrations of user interfaces, methods, and computer program products according to exemplary embodiments of the invention. It will be understood that each block of the flowchart illustrations, and combinations of blocks in the flowchart illustrations, can be implemented by computer program instructions These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

And each block of the flowchart illustrations may represent a module, segment, or portion of code, which comprises one or more executable instructions for implementing the specified logical function(s). It should also be noted that in some alternative implementations, the functions noted in the blocks may occur out of order. For example, two blocks shown in succession may in fact be executed substantially concurrently or the blocks may sometimes be executed in the reverse order, depending upon the functionality involved.

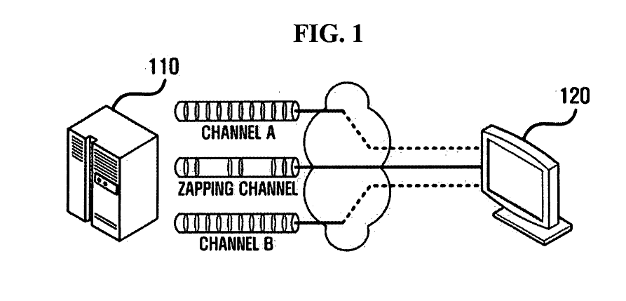

FIG. 1 is a schematic diagram of a broadcasting system according to an exemplary embodiment of the present invention. Referring to FIG. 1, the broadcasting system includes a broadcast-transmission apparatus 110 and a broadcast-reception apparatus 120. When a user watches a broadcast of channel A, the broadcast-reception apparatus 120 receives data of channel A and data of a zapping channel which are transmitted by the broadcast-transmission apparatus 110. Then, the broadcast-reception apparatus 120 outputs the channel A data on a screen.

The zapping channel is a channel obtained by multiplexing partial video data extracted from video data corresponding to each of a plurality of channels (i.e., channel A and channel B) serviced by the broadcast-transmission apparatus 110. Examples of the video data corresponding to each of the channels serviced by the broadcast-transmission apparatus 110 include various video broadcasted on a corresponding channel, program guide information of the corresponding channel and commercials.

When the user switches from channel A to channel B, the broadcast-reception apparatus 120 separates video data corresponding to channel B from zapping channel data, which is received as a background. Then, the broadcast-reception apparatus 120 is connected to channel B and receives a channel B data. Once the buffering of the channel B data is complete, the broadcast-reception apparatus 120 stops outputting the video data, corresponding to channel B, which is separated from the zapping channel, and outputs the buffered channel B data on the screen.

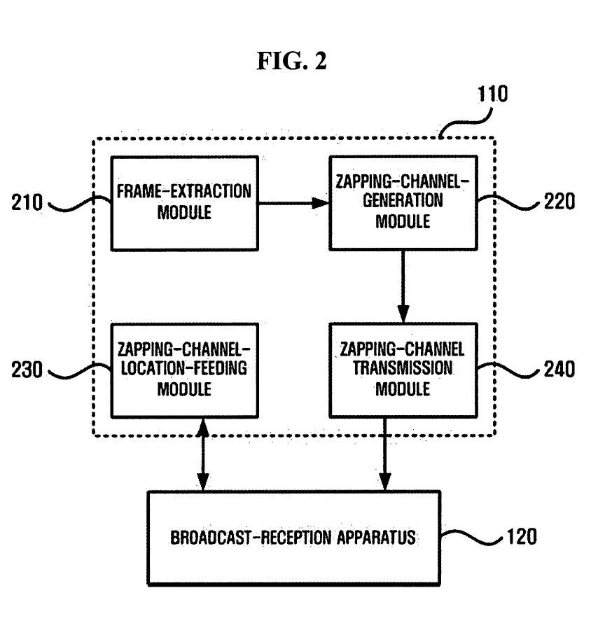

FIG. 2 is a block diagram of the broadcast-transmission apparatus 110, according to an exemplary embodiment of the present invention. Referring to FIG. 2, the broadcast-transmission apparatus 110 includes a frame-extraction module 210, a zapping-channel-generation module 220, a zapping-channel-location-feeding module 230, and a zapping-channel transmission module 240. The frame-extraction module 210 periodically extracts a partial video from video data corresponding to each of a number of channels currently being serviced. Examples of the video data corresponding to each of the channels include video data broadcasted on a corresponding channel, commercials corresponding to the channel, and program guide information of the corresponding channel. Specifically, the frame-extraction module 210 may periodically extract an I-frame from the video data corresponding to each of the channels. The right to configure content may be given to a service provider for each channel currently being serviced so that a variety of content corresponding to each channel currently being serviced can be provided.

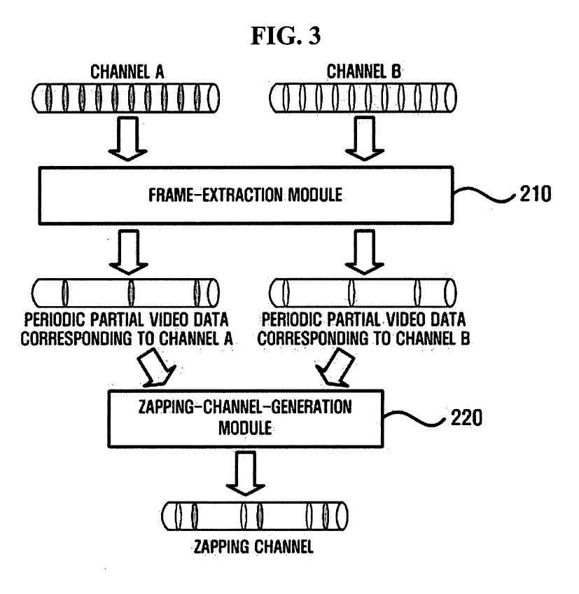

The frame-extraction module 210 generates periodic partial video data by adding up a number of partial videos provided by the broadcast-transmission apparatus 110. The generation of the periodic partial video data by the frame-extraction module 210 will be described later in further detail with reference to FIG. 3.

The frame-extraction module 210 generates metadata corresponding to each partial video extracted from the video data corresponding to each of the channels. The metadata includes channel information, range information and time information corresponding to a partial video. The frame-extraction module 210 may insert the metadata into the periodic partial video data so that the broadcast-reception apparatus 120 can easily identify a channel from which a corresponding partial video originates and a period of time of the channel for which the corresponding partial video accounts.

The zapping-channel-generation module 220 generates a zapping channel by multiplexing the periodic partial video data provided by the frame-extraction module 210. Multiplexing is a technique that divides a single transmission path and can thus configure a channel via which a plurality of independent signals can be transmitted or received at the same time. The generation of a zapping channel by the zapping-channel-generation module 220 will be described later in further detail with reference to FIG. 3.

The zapping-channel-location-feeding module 230 transmits access location information corresponding to the zapping channel generated by the zapping-channel-generation module 220. Specifically, the zapping-channel-location-feeding module 230 transmits the access location information using a unicast Uniform Resource Locator (URL) or a multicast group address so that the broadcast-reception apparatus 120 can search for the zapping channel generated by the zapping-channel-generation module 220. The access location information may be an Internet Protocol (IP) multicast address of the zapping channel generated by the zapping-channel-generation module 220.

The zapping-channel transmission module 240 transmits the data of the zapping channel generated by the zapping-channel-generation module 220. In the case of a live broadcast of IPTV programs, content is transmitted as an Moving Picture Experts Group (MPEG) transport stream (TS) using an IP multicast method. The IP multicast is a technique for simultaneously transmitting data to a group of users on a Transmission Control Protocol (TCP)/IP network. The zapping-channel transmission module 240 transmits the data of the zapping channel generated by the zapping-channel-generation module 220 as an MPEG TS using an IP multicast method.

The broadcast-transmission apparatus 110 may be included in a typical IPTV broadcast server or may constitute an independent server. Alternatively, only some of the modules of the broadcast-transmission apparatus 110 may be included in a typical IPTV broadcast server.

FIG. 3 illustrates the generation of a zapping channel by the broadcast-transmission apparatus 110 illustrated in FIG. 2, according to an exemplary embodiment of the present invention. Referring to FIG. 3, channels A and B are currently being serviced. The frame-extraction module 210 extracts a partial video from video data broadcasted on each of channels A and B. The extracted partial video may account for a certain time period of the video data being broadcasted on channel A or B.

Specifically, the frame-extraction module 210 periodically extracts an I-frame from the video data corresponding to each of channels A and B. I-frames in video compression include start and end frames of a predetermined operation. Unlike P-frames or B-frames, I-frames can constitute an independent scene. Therefore, the frame-extraction module 210 may periodically extract an I-frame from the video data corresponding to each of channels A and B, and generate periodic partial video data by adding up a number of I-frames that are extracted from the video data corresponding to each of channels A and B.

The frame-extraction module 210 generates metadata corresponding to each I-frame extracted from the video data corresponding to each of the channels A and B. The metadata includes channel information, range information and time information corresponding to each I-frame extracted from the video data corresponding to each of channels A and B. The frame-extraction module 210 may insert the metadata into periodic partial video data so that the broadcast-reception apparatus 120 can easily identify a channel from which a corresponding I-frame originates and a period of time of the channel for which the corresponding I-frame accounts.

Periodic partial video data corresponding to each channel currently being serviced may be multiplexed by the zapping-channel-generation module 220. Specifically, the zapping-channel-generation module 220 generates a zapping channel by multiplexing periodic partial video data corresponding to channel A and periodic partial video data corresponding to channel B. The zapping-channel-generation module 220 may generate a zapping channel by multiplexing a number of I-frames obtained from channel A, metadata corresponding to each of the I-frames obtained from channel A, a number of I-frames obtained from channel B, and metadata corresponding to each of the I-frames obtained from channel B.

The exemplary embodiment of FIG. 3 has been described above on the assumption that there are only two channels currently being serviced. However, the exemplary embodiment of FIG. 3 can be applied to the situation when there are more than two channels currently being serviced.

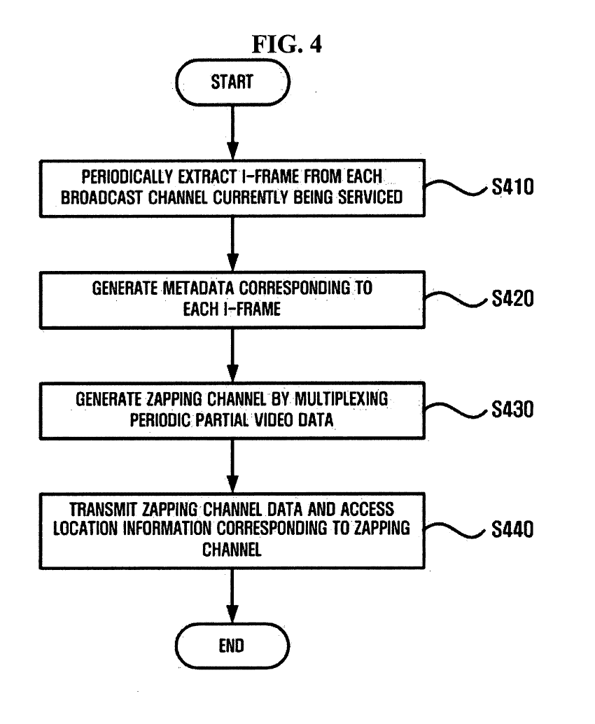

FIG. 4 is a flowchart illustrating a method of providing a zapping channel according to an exemplary embodiment of the present invention. Referring to FIG. 4, the frame-extraction module 210 periodically extracts an I-frame from video data corresponding to each of a plurality of channels currently being serviced (S410). Specifically, the frame-extraction module 210 periodically extracts an I-frame from the video data corresponding to each of the channels currently being serviced, and generates periodic partial video data corresponding to each of the channels currently being serviced by adding up a number of I-frames that are extracted from the video data corresponding to each of the channels currently being serviced.

The frame-extraction module 210 generates metadata corresponding to each of the extracted I-frames (S420). The metadata includes channel information, range information, and time information of each of the extracted I-frames. The frame-extraction module 210 may insert the metadata into periodic partial video data so that the broadcast-reception apparatus 120 can easily identify a channel from which a corresponding I-frame originates and a period of time of the channel for which the corresponding I-frame accounts.

The zapping-channel-generation module 220 generates a zapping channel by multiplexing periodic partial video data corresponding to each of the channels currently being serviced (S430). The zapping-channel-generation module 220 may generate a zapping channel by multiplexing periodic partial data from all the channels being serviced.

The zapping-channel-location-feeding module 230 transmits service information and access location information corresponding to the zapping channel, and the zapping-channel transmission module 240 transmits the zapping channel data (S440). Specifically, the access location information transmission channel 230 transmits an IP multicast address of the zapping channel, and the zapping-channel transmission module 240 transmits the zapping channel data as an MPEG TS using the IP multicast method.

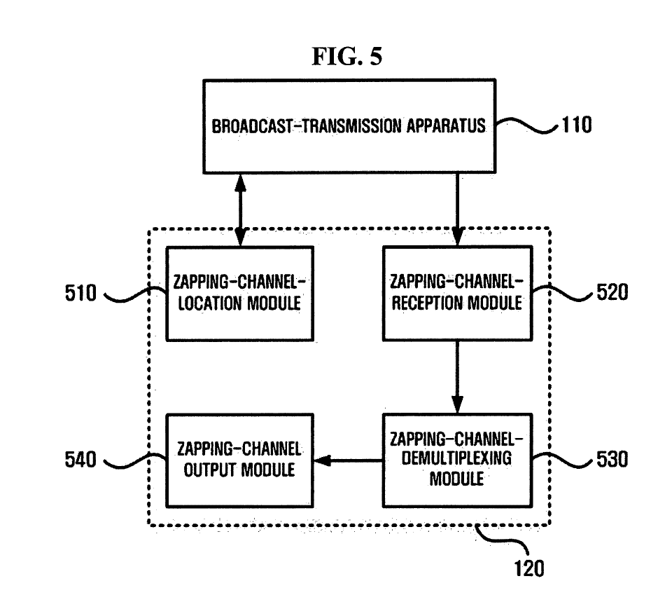

FIG. 5 is a block diagram of the broadcast-reception apparatus 120 illustrated in FIG. 2, according to an exemplary embodiment of the present invention. Referring to FIG. 5, the broadcast-reception apparatus 120 includes a zapping-channel-location module 510, a zapping-channel-reception module 520, a zapping-channel-demultiplexing module 530, and a zapping-channel output module 540.

The zapping-channel-location module 510 receives access location information from the zapping-channel-location-feeding module 230 of the broadcast-transmission apparatus 110 and identifies an IP multicast address of a zapping channel.

In order to receive a zapping channel, the zapping-channel-location module 510 may identify access location information corresponding to the zapping channel as soon as the broadcast reception module 120 is activated.

The zapping-channel-reception module 520 connects the broadcast reception module 120 to a zapping channel corresponding to the access location information identified by the zapping-channel-location module 510, and thus receives zapping channel data. The zapping-channel-reception module 520 may continuously receive zapping channel data as long as the broadcast-reception apparatus 120 operates. The zapping-channel-reception module 520 may receive zapping channel data which is transmitted as an MPEG TS using an IP multicast method by the broadcast-transmission apparatus 110.

The zapping-channel-demultiplexing module 530 obtains a number of partial videos for each channel by demultiplexing the zapping channel data received by the zapping-channel-reception module 520. The zapping-channel-demultiplexing module 530 identifies a number of channels corresponding to each of the partial videos of the zapping channel, based on channel information of metadata present in the zapping channel data, and obtains a number of partial videos corresponding to each of the identified channels by demultiplexing the zapping channel data. The demultiplexing of the zapping channel may be performed for all the identified channels regardless of whether a user has issued a channel-switching request. Alternatively, the demultiplexing of the zapping channel may be performed only for a certain channel in response to a channel-switching request issued by the user.

Examples of the partial video obtained by the zapping-channel-demultiplexing module 530 include I-frames, program guide information, and commercials.

The zapping-channel output module 540 outputs the partial video obtained by the zapping-channel-demultiplexing module 530 on a screen. When the user switches from a first channel to a second channel, the zapping-channel output module 540 may continuously output a number of partial videos corresponding to the second channel on the screen until main data of the second channel is output on the screen.

If the partial video obtained by the zapping-channel-demultiplexing module 530 are I-frames, the zapping-channel output module 540 may output the I-frames on the screen as a slideshow or as thumbnails.

The broadcast-reception apparatus 120 may be included in a typical IPTV terminal.

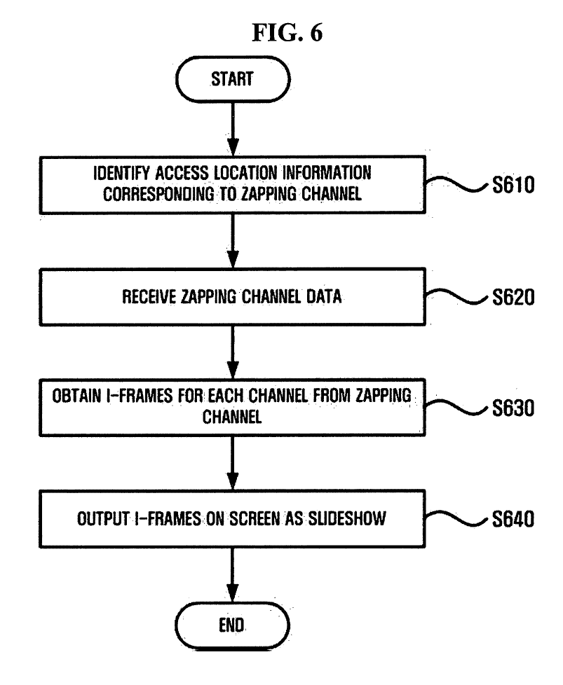

FIG. 6 is a flowchart illustrating a method of outputting a zapping channel according to an exemplary embodiment of the present invention. Referring to FIG. 6, the zapping-channel-location module 510 identifies access location information corresponding to a zapping channel, which is obtained by multiplexing periodic partial video data corresponding to a number of channels currently being serviced (S610). Specifically, the zapping-channel-location module 510 receives access location information from the zapping-channel-location-feeding module 230 of the broadcast-transmission apparatus 110, and identifies an IP multicast address of a zapping channel based on the received access location information.

The zapping-channel-reception module 520 connects the broadcast-reception apparatus 120 to a zapping channel corresponding to the access location information identified by the zapping-channel-location module 510 and thus receives zapping channel data (S620). Specifically, the zapping-channel-reception module 520 receives zapping channel data which is transmitted as an MPEG TS using an IP multicast method by the broadcast-transmission apparatus 110.

The zapping-channel-demultiplexing module 530 obtains the number of I-frames corresponding to each of the channels currently being serviced by demultiplexing the zapping channel received by the zapping-channel-reception module 520 (S630) with reference to channel information of metadata included in the zapping channel received by the zapping-channel-reception module 520. The demultiplexing of the zapping channel may be performed for all the channels currently being serviced regardless of whether a user has issued a channel-switching request. Alternatively, the demultiplexing of the zapping channel may be performed only for a certain channel in response to a channel-switching request issued by the user. According to the exemplary embodiment of FIG. 6, the demultiplexing of the zapping channel may be performed for all the channels currently being serviced.

Examples of the I-frames obtained by the zapping-channel-demultiplexing module 530 include program guide information and commercials.

When the user switches from one channel to another, the zapping-channel output module 540 outputs the I-frames obtained by the zapping-channel-demultiplexing module 530 on a screen as a slideshow. Alternatively, the zapping-channel output module 540 outputs the I-frames obtained by the zapping-channel-demultiplexing module 530 on the screen as thumbnails.

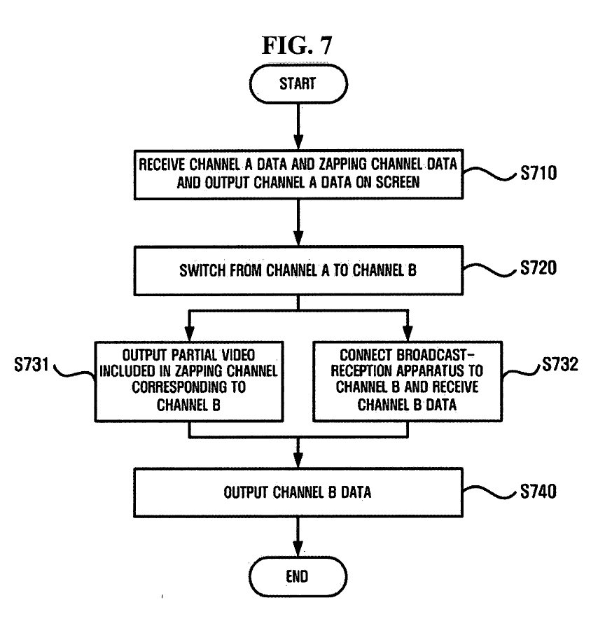

FIG. 7 is a flowchart illustrating a channel-switching method according to an exemplary embodiment of the present invention. Referring to FIG. 7, when a user is currently watching a broadcast of channel A, the broadcast-reception apparatus 120 receives channel A data and a zapping channel data, and outputs channel A data on a screen (S710). The zapping-channel-location module 510 of the broadcast-reception apparatus 120 identifies access location information of the zapping channel as soon as the broadcast-reception apparatus 120 is activated, and the zapping-channel-reception module 520 of the broadcast-reception apparatus 120 continuously receives the zapping channel data.

Next, a user inputs a channel-switching request to switch from channel A to channel B (S720).

The broadcast-reception apparatus 120 receives the channel-switching request, and the zapping-channel output module 540 of the broadcast-reception apparatus 120 outputs a number of partial videos included in the zapping channel corresponding to channel B (S731).

The partial video corresponding to channel B is obtained by demultiplexing the zapping channel data with reference to channel information of metadata present in the zapping channel data with the use of the zapping-channel-demultiplexing module 530 of the broadcast-reception apparatus 120. The demultiplexing of the zapping channel may be performed for all of a plurality of identified channels currently being serviced regardless of the channel-switching request. Alternatively, the demultiplexing of the zapping channel may be performed only for channel B in response to the channel-switching request. The zapping-channel output module 540 outputs a partial video corresponding to channel B which is most recent on the screen with reference to time information of the metadata in the zapping channel.

If the partial video corresponding to channel B is I-frames obtained from channel B, the zapping-channel output module 540 may output the I-frames as a slide show or as thumbnails. If the partial video corresponding to channel B are program guide information or commercials corresponding to channel B, the zapping-channel output module 540 may output the program guide information or the commercials.

When the broadcast-reception apparatus 120 receives the channel-switching request, the broadcast-reception apparatus 120 is connected to channel B, and receives channel B data (S732) while outputting the partial video corresponding to channel B on the screen. Specifically, the broadcast-reception apparatus 120 is connected to an IP multicast address of channel B, receives channel B data, and buffers a predetermined amount of data.

When the buffering of the data is completed, the broadcast-reception apparatus 120 performs decoding, and outputs channel B data on the screen (S740). As soon as channel B data is output on the screen, the output of the partial video corresponding to channel B on the screen is terminated.

The channel-switching method illustrated in FIG. 7 can be applied not only to an IPTV but also various broadcasting systems which may cause a delay in switching between channels.

The term “module”, as used herein, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules, or further separated into additional components and modules.

As described above, according to the exemplary embodiments of the present invention, it is possible to display partial video data corresponding to a channel during a blank period caused by a channel switching delay.

In addition, according to the exemplary embodiments of the present invention, it is possible to quickly switch from a first channel to a second channel based on partial video data corresponding to the second channel.

Moreover, according to the exemplary embodiments of the present invention, it is possible for a service provider to provide program guide information or commercials by making it possible for the service provider to configure a scene to be displayed during a channel switching operation.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A broadcast-transmission apparatus comprising:
a frame-extraction module which extracts partial videos, wherein each of the partial videos is extracted from video data corresponding to each of a plurality of channels currently being serviced;
a zapping-channel-generation module which generates a zapping channel by multiplexing the partial videos; and
a zapping-channel transmission module which transmits the multiplexed partial videos.

2. The broadcast-transmission apparatus of claim 1, further comprising a zapping-channel-location-feeding module which transmits access location information corresponding to the zapping channel.

3. The broadcast-transmission apparatus of claim 1, wherein the each of the partial videos comprises I-frames of the video data.

4. The broadcast-transmission apparatus of claim 1, wherein the frame-extraction module generates metadata corresponding to the each of the partial videos.

5. The broadcast-transmission apparatus of claim 1, wherein the video data corresponding to the plurality of channels comprises broadcast program guide information corresponding to each of the plurality of channels.

6. The broadcast-transmission apparatus of claim 1, wherein the video data corresponding to each of the plurality of channels comprises commercials of each of the plurality of channels.

7. The broadcast-transmission apparatus of claim 1, wherein the each of the partial videos is periodically extracted from the video data corresponding to the plurality of channels currently being serviced.

8. A method of providing data of a zapping channel, comprising:
extracting partial videos;
generating a zapping channel by multiplexing the partial videos; and
transmitting the multiplexed partial videos,
wherein each of the partial videos is extracted from video data corresponding to a plurality of channels currently being serviced.

9. The method of claim 8, further comprising transmitting access location information corresponding to the zapping channel.

10. The method of claim 8, wherein the each of the partial videos comprises I-frames of the video data corresponding to the plurality of channels.

11. The method of claim 8, further comprising generating metadata corresponding to the each of the partial videos.

12. The method of claim 8, wherein the each of the partial videos is periodically extracted from the video data corresponding to the plurality of channels currently being serviced.

13. A broadcast-reception apparatus comprising:
a zapping-channel-reception module which receives data included in a zapping channel that is obtained by multiplexing a plurality of partial videos, wherein each of the plurality of partial videos is extracted from video data corresponding to a plurality of channels currently being serviced;
a zapping-channel-demultiplexing module which obtains the plurality of partial videos respectively corresponding to the plurality of channels by demultiplexing the data included in the zapping channel; and
a zapping-channel output module which outputs a partial video of the plurality of partial videos obtained by the zapping-channel-demultiplexing module on a screen upon switching channels.

14. The broadcast-reception apparatus of claim 13, further comprising a zapping-channel-location module which identifies access location information corresponding to the zapping channel.

15. The broadcast-reception apparatus of claim 13, wherein each of the plurality of partial videos obtained by the zapping-channel-demultiplexing module comprises I-frames of the video data corresponding to the plurality of channels, and
wherein the zapping-channel-output module outputs the partial video as a slideshow.

16. A method of outputting data of a zapping channel, comprising:
receiving data included in a zapping channel which is obtained by multiplexing a plurality of partial videos, wherein each of the plurality of partial videos is extracted from video data corresponding to a plurality of channels currently being serviced;
obtaining the plurality of partial videos respectively corresponding to the plurality of channels by demultiplexing the data included in the zapping channel; and
outputting a partial video of the obtained plurality of partial videos on a screen upon switching channels.

17. The method of claim 16, further comprising identifying access location information corresponding to the zapping channel.

18. The method of claim 16, wherein each of the obtained plurality of partial videos comprises I-frames of the video data corresponding to the plurality of channels, and
wherein the outputting the partial video comprises outputting the partial video as a slideshow.

19. A channel-switching method comprising:
switching from a first channel to a second channel;
outputting a partial video corresponding to the second channel on a screen; and
outputting main data of the second channel on the screen,
wherein the partial video is extracted from video data corresponding to the second channel and output on the screen before the main data of the second channel is output on the screen.

20. The channel-switching method of claim 19, wherein the partial video comprises a plurality of I-frames extracted from the video data corresponding to the second channel.

21. The channel-switching method of claim 19, wherein the partial video comprises a plurality of I-frames periodically extracted from the video data corresponding to the second channel.

22. The channel-switching method of claim 19, wherein the outputting a partial video comprises outputting as a slideshow a plurality of I-frames periodically extracted from the video data corresponding to the second channel.

23. The channel-switching method of claim 19, wherein the outputting a partial video comprises outputting as thumbnails a plurality of I-frames periodically extracted from the video data corresponding to the second channel.

24. The channel-switching method of claim 19, wherein the video data corresponding to the second channel comprises broadcast program guide information corresponding to the second channel.

25. The channel-switching method of claim 19, wherein the video data corresponding to the second channel comprises commercials of the second channel.
